(19) United States
(12) Patent Application Publication
(10) Pub. No.: US 2022/0133584 A1
(43) Pub. Date: May 5, 2022

(54) HANDHELD VIBRATING APPARATUS HAVING A HANDLE

(71) Applicant: BE Goods LLC DBA Sweet Vibes, San Diego, CA (US)

(72) Inventor: Nicolas Bouyounes, San Diego, CA (US)

(21) Appl. No.: 17/326,704

(22) Filed: May 21, 2021

Related U.S. Application Data
(63) Continuation-in-part of application No. 29/756,972, filed on Nov. 2, 2020.

(51) Int. Cl. A61H 19/00; A61H 23/02

(52) U.S. Cl. CPC A61H 19/34; A61H 2201/0153; A61H 2201/16; A61H 23/02

(57) ABSTRACT

A handheld vibrating includes a body having a handle extending centrally along its top surface along a vertical longitudinal plane. The handle includes sidewalls each having a concave shape configured to complement a shape of a respective one of two adjacent fingers on a user's hand such that the handle is configured to be gripped, at the sidewalls, by adjacent sides of the two adjacent fingers on the user's hand. The body includes at least one selector disposed on a side thereof and sufficiently posteriorly offset from the handle that the at least one selector is aligned with a resting position of the thumb when the handle is gripped by the user's two adjacent fingers. A flexible vibrating fin extends away from a bottom surface of the body. The apparatus includes a motor configured to move the vibrating fin in one or more oscillatory patterns. Related methods are also provided.

### CROSS-REFERENCE TO RELATED APPLICATIONS

This application claims the benefit of the filing date of U.S. Design Pat. Application No. 29/756,972, filed on Nov. 2, 2020 and entitled “Handheld Vibrating Apparatus Having a Handle,” the disclosure of which is hereby incorporated by reference herein in its entirety.

### BACKGROUND

The present disclosure relates to a handheld vibrating apparatus having a handle and associated methods.

While massaging apparatuses are known, many are not sufficiently ergonomically designed for ease of use. For example, it can be difficult to reach some areas of the body that a user might desire to massage. To make such situations more difficult and less relaxing, many massaging apparatuses are cumbersome when appropriately gripped and extended to reach harder-to-reach body locations, which makes the massaging process difficult, less enjoyable, and can, in some cases, exacerbate peripheral maladies, such as sore, tired and/or cramping arm, forearm, hand, and/or finger muscles.

Accordingly, a need exists for handheld vibrating apparatuses having a handle and associated methods that provide for comfortable, ergonomic use of such handheld vibrating apparatuses.

### SUMMARY

In some embodiments, a handheld vibrating apparatus is provided. The apparatus includes a body. The body includes a handle extending centrally along a top surface of the body along a vertical longitudinal plane that passes through a center of the body. The handle includes sidewalls each having a concave shape configured to complement a shape of a respective one of two adjacent fingers on a user's hand such that the handle is configured to be gripped, at the sidewalls, by adjacent sides of the two adjacent fingers on the user's hand. The body includes at least one selector disposed on a side of the body and sufficiently offset from the handle in the posterior direction that the at least one selector is aligned with a resting position of the thumb of the user's hand when the handle is gripped by the adjacent sides of the two adjacent fingers on the user's hand. The body includes a bottom surface. The apparatus includes a flexible vibrating fin extending away from the bottom surface. The apparatus includes a motor configured to move the vibrating fin in one or more oscillatory patterns configured to massage a desired portion of the user's body.

In some other embodiments, a method of using a handheld vibrating apparatus is provided. The method includes gripping concave-shaped sidewalls of a handle of a body of the apparatus between adjacent sides of two adjacent fingers on a user's hand. The handle extends centrally along a top surface of the body along a vertical longitudinal plane that passes through a center of the body and the concave-shaped sidewalls being configured to complement a shape of the two adjacent fingers on a user's hand. The method includes while gripping the concave-shaped sidewalls, disposing the thumb of the user's hand, in a resting position, directly on at least one selector that is disposed on a side of the body and sufficiently offset from the handle in the posterior direction to allow the thumb to be naturally so-disposed. The method includes using the user's thumb, while naturally so-disposed, to select an oscillatory pattern for a flexible vibrating fin that extends away from a bottom surface of the body of the apparatus. The method includes disposing the bottom surface of the body of the apparatus on the user's body such that the flexible vibrating fin is in direct contact with and massages a desired portion of the user's body.

In some other embodiments, a method of manufacturing a handheld apparatus is provided. The method includes forming a body of the apparatus having a top surface and a bottom surface. The method includes forming a handle that extends centrally along the top surface along a vertical longitudinal plane that passes through a center of the body. The handle includes sidewalls each having a concave shape configured to complement a shape of a respective one of two adjacent fingers on a user's hand such that the handle is configured to be gripped, at the sidewalls, by adjacent sides of the two adjacent fingers on the user's hand. The method includes disposing at least one selector on a side of the body and sufficiently offset from the handle in the posterior direction that the at least one selector is aligned with a resting position of the thumb of the user's hand when the handle is gripped by the adjacent sides of the two adjacent fingers on the user's hand. The method includes disposing a flexible vibrating fin within body such that the flexible vibrating fin extends away from the bottom surface. The method includes disposing a motor within the body, the motor configured to move the vibrating fin in one or more oscillatory patterns configured to massage a desired portion of the user's body.

### BRIEF DESCRIPTION OF THE DRAWINGS

A more complete appreciation of the subject matter of the present disclosure and of the various advantages thereof can be realized by reference to the following detailed description in which reference is made to the accompanying drawings in which:

FIG. 1 is a schematic diagram of a handheld vibrating apparatus having a handle, according to some example embodiments;

FIG. 2 is a perspective top view of a handheld vibrating apparatus, according to some example embodiments;

FIG. 3 is a first side view of the handheld vibrating apparatus of FIG. 2, according to some example embodiments;

FIG. 4 is a second side view, opposite the view of FIG. 3, of the handheld vibrating apparatus of FIG. 2, according to some example embodiments;

FIG. 5 is a front view of the handheld vibrating apparatus, according to some example embodiments;

FIG. 6 is a back view of the handheld vibrating apparatus, according to some example embodiments;

FIG. 7 is a top view of the handheld vibrating apparatus, according to some example embodiments;

FIG. 8 is a bottom view of the handheld vibrating apparatus, according to some example embodiments;

FIG. 9 is a perspective bottom view of the handheld vibrating apparatus, according to some example embodiments;

FIG. 10 is a flowchart related to a method of using a handheld vibrating apparatus; and

FIG. 11 is a flowchart related to a method of manufacturing a handheld vibrating apparatus, according to some example embodiments.

### DETAILED DESCRIPTION

The present disclosure relates to handheld vibrating apparatuses and associated methods. Several inventive embodiments are described below.

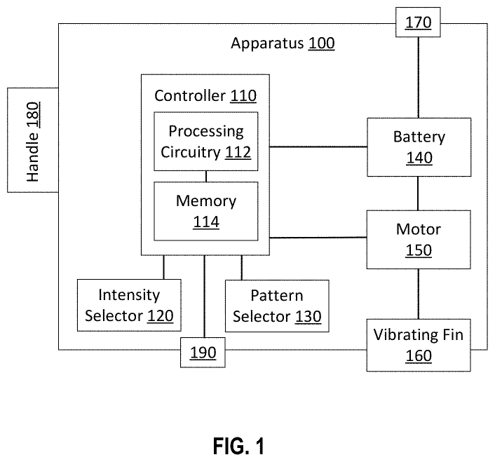

For example, FIG. 1 is a schematic diagram of a handheld vibrating apparatus 100 having a handle 180, according to some example embodiments. As will be described in more detail in connection with at least one figure below, handle 180 may comprise a flexible grip configured to be disposed, longitudinally, between two of a user's adjacent fingers, e.g., index finger and middle finger, thereby allowing the user to ergonomically hold and direct at least a portion of apparatus 100 in physical contact with a portion of the user's body, e.g., the user's clitoris, thereby allowing apparatus 100 to be operated substantially as an extension of the user's hand. In some embodiments, handle 180 comprises silicone. However, the present disclosure is not so limited and handle 180 can comprise any suitably flexible material.

Apparatus 100 may include a battery 140 configured to power any component(s) within apparatus 100 requiring power. In some embodiments, battery 140 comprises a lithium-ion battery. However, the present disclosure is not so limited and battery 140 can comprise any suitable electrical power storage, whether single-use or rechargeable.

Apparatus 100 may further include a flexible vibrating fin 160 configured to massage the portion of the human body, e.g., the clitoris. In some embodiments, vibrating fin 160 has a shape, texture and/or pliability of, or similar to, that of at least a tip of a human tongue. In some embodiments, vibrating fin 160 comprises silicone. However, the present disclosure is not so limited and vibrating fin 160 can comprise any suitable material.

Apparatus 100 may further include a motor 150 configured to move vibrating fin 160 in one or more oscillatory patterns configured to provide massage-based stimulation of the portion of the body in physical contact with vibrating fin 160. As will be described in more detail in connection with one or more FIGS. below, a shape of a body of apparatus 100 may be such that a substantially rounded top side of apparatus 100, opposite of vibrating fin 160, also vibrates, though to a relatively lesser extent compared to vibrating fin 160, thereby simultaneously offering a user a different vibratory and/or massaging sensation when the substantially rounded top side of apparatus 100 is placed in physical contact with the portion of the body. In some such embodiments, the body of apparatus 100 can also comprise silicone or any other suitable material.

Apparatus 100 may further include a controller 110 configured to regulate at least one aspect of operation of apparatus 100, motor 150 and/or vibrating fin 160. In some embodiments, controller 110 may include processing circuitry 112 configured to affect any regulation, control, selection and/or adjustment of any function of apparatus 100 described herein. Apparatus 100 may further include memory 114 configured to store at least one piece of data related to any regulation, control, selection and/or adjustment of any function of apparatus 100 described herein. Controller 110, processing circuitry 112 and/or memory 114 may be, or comprise a portion of, any suitable control circuitry, processor(s) and/or microprocessor(s).

Apparatus 100 may further include a pattern selector 130 configured to allow a user to select one of a plurality of vibratory and/or oscillatory patterns for vibrating fin 160. For example, apparatus 100, controller 110 and/or pattern selector 130 may be configured to change a state of vibration of vibrating fin 160 between an ON state and an OFF state upon pressing pattern selector 130 for a predetermined length of time, e.g., 3-5 seconds. One advantage of utilizing such a predetermined length of time, e.g., 3-5 seconds, for pattern selector 130 to change state between ON and OFF is prevention of accidental activation of apparatus 100, for example, while being transported in luggage.

In some embodiments, apparatus 100, controller 110 and/or pattern selector 130 may be configured to cause a light emitting source 190 to illuminate when apparatus 100 is in the ON state and/or to not illuminate when apparatus 100 is in the OFF state. In some embodiments, apparatus 100, controller 110 and/or pattern selector 130 may be configured to select one of a plurality of patterns of vibration of vibrating fin 160 by briefly pressing pattern selector 130 for a different predetermined length of time, e.g., less than one second. For example, once apparatus 100 is in the ON state, each brief press of pattern selector 130 may be configured to incrementally advance through each of 5 different vibration patterns for vibrating fin 160.

Apparatus 100 may further include an intensity selector 120 configured to allow a user to select one of a plurality of intensities of the currently selected vibratory and/or oscillatory pattern for vibrating fin 160. For example, apparatus 100, controller 110 and/or intensity selector 120 may be configured to select one of a plurality of intensities and/or speeds of vibration for vibrating fin 160 by briefly pressing intensity selector 120 for a second predetermined length of time, e.g., less than one second. For example, once apparatus 100 is in the ON state, each such brief press of intensity selector 120 may be configured to incrementally advance through each of 5 different intensities and/or speeds for vibrating fin 160.

Apparatus 100 may further include a charging port 170 configured to receive external electrical power for charging battery 140 and/or directly powering apparatus 100. Charging port 170 can comprise any suitable electrical connection and/or conduit, for example, a USB port configured to receive electrical power from a traditional wall electrical plug.

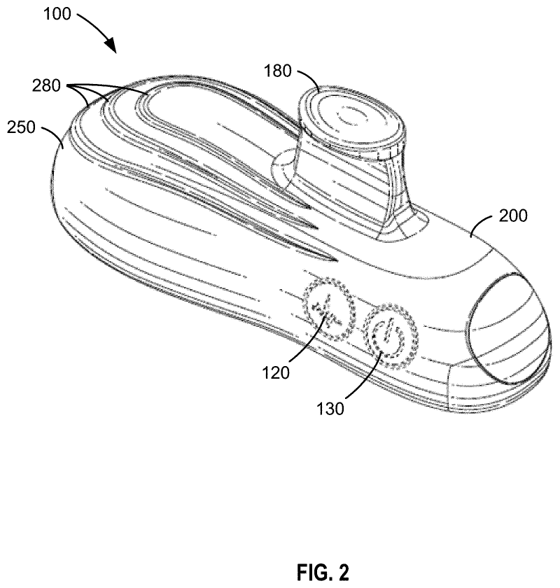

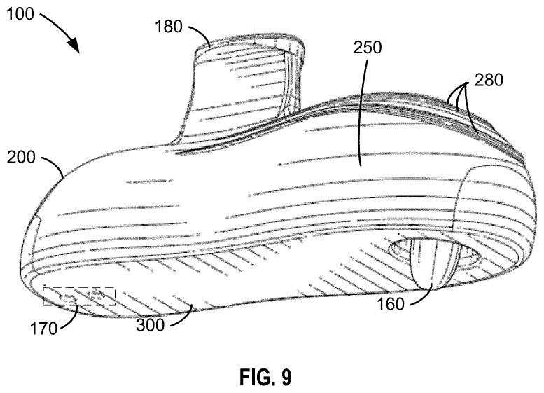

Several advantageous features of apparatus 100 will now be described in more detail in connection with at least FIGS. 2-9, each of which illustrates a different view of apparatus 100.

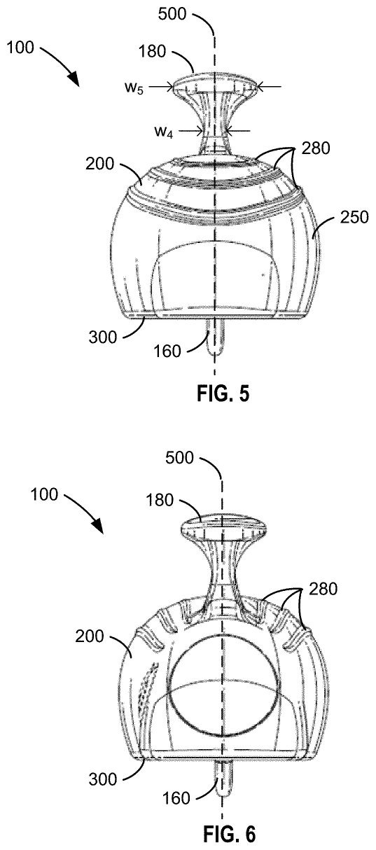

As shown in FIGS. 2-9, apparatus 100 comprises a body 200. In some embodiments, body 200 comprises silicone. However, the present disclosure is not so limited and body 200 may comprise any appropriately compliant material. In some embodiments, body 200 of apparatus 100 is substantially symmetrical about a vertical, longitudinal plane 500 (see, e.g., FIGS. 5-8) passing through a center of apparatus 100. In some embodiments, body 200 comprises a substantially planar bottom surface 300 and vibrating fin 160 extends away from substantially planar bottom surface 300. Such a planar bottom surface 300 can allow for ergonomic placement of vibrating fin 160 and/or a portion of planar bottom surface 300 on the desired portion of the user's body. While any other position is also contemplated, charging port 170 is illustrated as disposed on a posterior portion of planar bottom surface 300 of body 200.

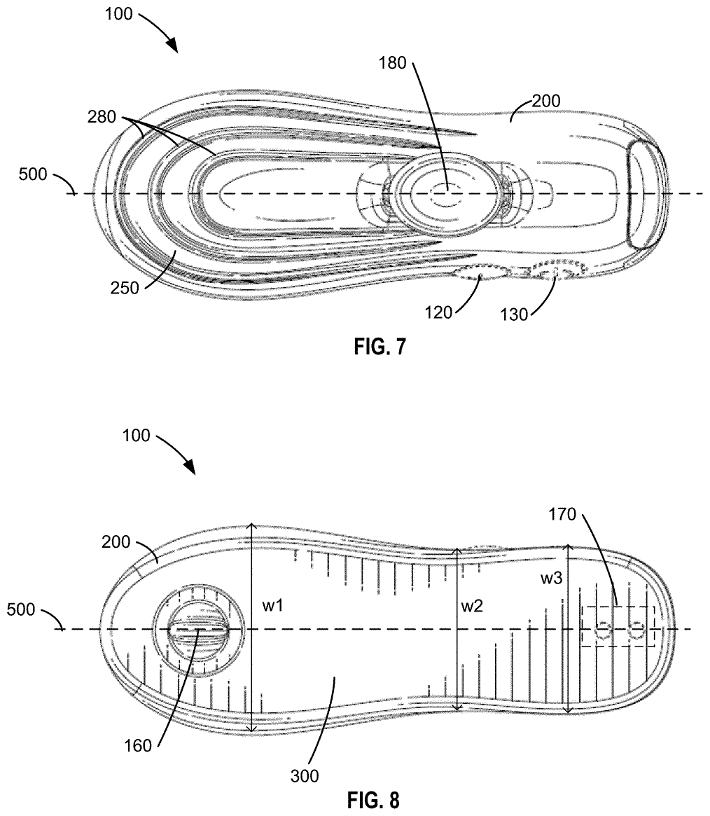

In some embodiments, as best illustrated in FIGS. 7 and 8, body 200 of apparatus 100 may have a substantially shoe-shaped perimeter and/or outer contour that is symmetrical about vertical longitudinal plane 500, as viewed from the top or bottom of apparatus 100. More specifically, body 200 may have a curved outer profile (as viewed from the top or bottom of apparatus 100) that increases in width, as body 200 extends from a front end along vertical longitudinal plane 500, to a first local maximum value w₁ at a portion of body 200 anterior of an anterior-posterior midline of body 200. A width of body 200 then decreases from the maximum value w₁, as body 200 extends further along vertical longitudinal plane 500, ending at a back end of body 200. In some embodiments, the width of body 200 may increase slightly again from the local minimum mid-body value w₂ to a second local maximum width w₃, as body 200 extends further along vertical longitudinal plane 500 and before decreasing again at the back end of body 200. Such an above-described “shoe-shape” of body 200 may be advantageous at least in that it provides an ergonomic shape that complements a user's hand, fingers and thumb when holding apparatus 100 and makes accessing one or more controls (e.g., see selectors 120, 130 of FIG. 1) easier for the user.

In some embodiments, body 200 comprises a substantially rounded top side 250, vertically opposite (and/or substantially over) the portion of planar bottom surface 300 from which vibrating fin 160 extends. At least one advantage of substantially rounded top side 250 is that it also vibrates when vibrating fin 160 vibrates, though to a relatively lesser extent, thereby simultaneously offering a user a different vibratory and/or massaging sensation when substantially rounded top side 250 is placed in physical contact with the desired portion of the body.

In some embodiments, body 200 comprises one or more ridges 280 extending along an outer contour of at least a portion of a top side of body 200, for example, substantially rounded top side 250. In some embodiments, ridges 280 may be integrally formed with body 200. In some such embodiments, ridges 280 may be substantially continuous along their entire path of extension. In some such embodiments, ridges 280 may comprise a same material as body 200, for example silicone. At least one advantage provided by ridges 280 is that of increased and/or different massage and/or vibratory stimulation at the desired portion of the user's body when substantially rounded top side 250 and ridges 280 of body 200 are disposed in physical contact therewith.

Apparatus 100 further comprises a handle or grip 180. As best illustrated by FIGS. 5 and 6, handle 180 extends centrally along a top surface of body 200 along vertical, longitudinal plane 500. Handle 180 is configured to be gripped on either side by adjacent sides of two adjacent fingers on a user's hand, for example, an index (pointer) finger and a middle finger, or a middle finger and a ring finger on a same hand of the user, such that, when appropriately held by the user, apparatus 100 projects substantially distally away from the user's hand and functions substantially as a natural extension of the user's hand, making placing and operating apparatus 100 substantially easier and more enjoyable for the user compared to other designs. Accordingly, sidewalls of handle 180 may have a substantially concave shape that accommodates and compliments the shape of the user's fingers as described above. Accordingly, in such embodiments, a minimum horizontal width w₄ of handle between the concave side walls is substantially smaller than a maximum horizontal width w₅ of a top, head or cap of handle 180. The larger width w₅ compared to w₄ described above provides the advantage of preventing apparatus 100 from unintentionally falling out of the user's grip. This is especially advantageous when considering that the average user has less strength in pinching two adjacent fingers together laterally (as for a user holding specially designed handle 180) than, for example, closing those fingers toward the palm of the hand or pinching the thumb against any of the fingers, as would occur with a more traditionally oriented handle and gripping style. In some embodiments, the top, head or cap of handle 180 may have a substantially ovoid or elliptical shape as viewed from the top (see, e.g., FIG. 7). However, the present disclosure is not so limited and the top, head or cap of handle 180 is also contemplated to have any alternative shape.

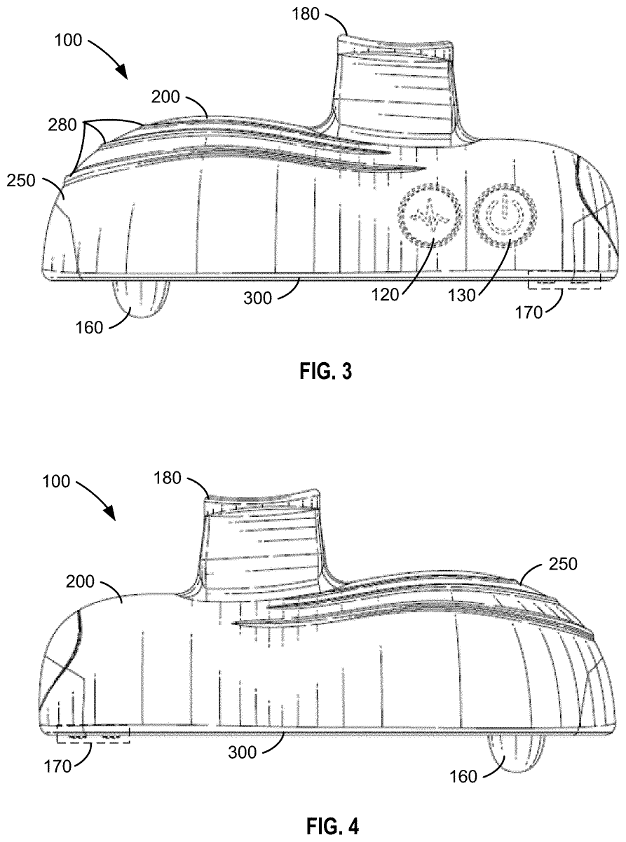

In some embodiments, for example as best illustrated in FIGS. 5 and 6, handle 180 may be substantially in line, vertically, with vibrating fin 160, both shown centered laterally about vertical longitudinal plane 500. In some embodiments, for example as best illustrated in FIGS. 3 and 4, handle 180 may be disposed near an anterior-posterior midpoint of body 200, for example, slightly posterior of such an anterior-posterior midpoint. In some embodiments, intensity selector 120 and/or pattern selector 130 may be disposed on a same side of body 200 but slightly offset posteriorly from handle 180. This positioning of selectors 120, 130 is deliberate and has at least one advantage of being aligned with the natural or resting position of the user's thumb when handle 180 is gripped between the index and middle fingers of the user's hand, e.g., right hand as illustrated in FIG. 3 but left hand, with opposite-side selector disposition, is also contemplated. This allows the user to adjust one or more aspects of operation of apparatus 100 while simultaneously and continuously maintaining firm grip and physical control of apparatus 100.

Example Method(s) of Use

The disclosure now turns to one or more example methods of utilizing a handheld vibrating apparatus as described anywhere in this disclosure.

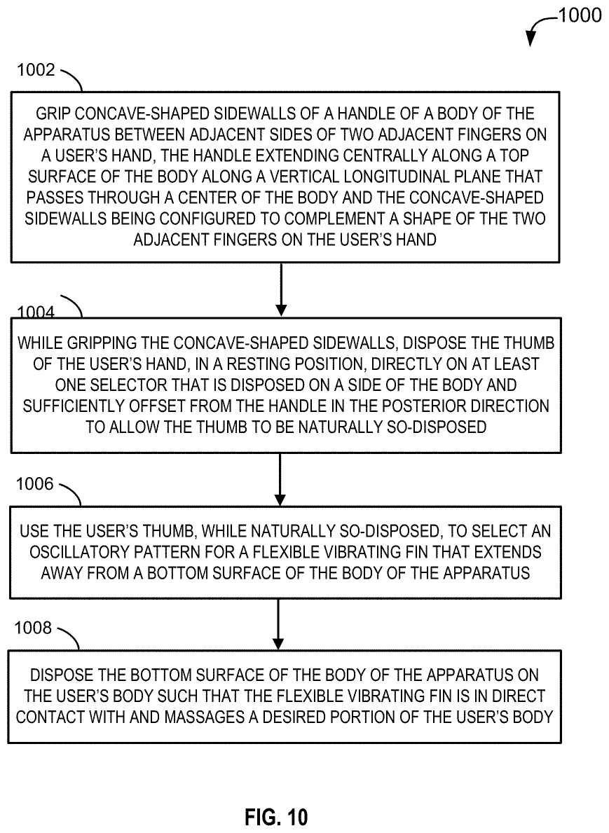

FIG. 10 illustrates a flowchart 1000 for an example method of utilizing a handheld vibrating apparatus, as described anywhere in this disclosure. Although particular steps are described herein, the present application is not so limited and alternative methods of manufacturing a handheld vibrating apparatus may include a subset of these steps, in the same or different order, and may additionally include one or more addition steps not described herein.

Step 1002 includes gripping concave-shaped sidewalls of a handle of a body of the apparatus between adjacent sides of two adjacent fingers on a user's hand, the handle extending centrally along a top surface of the body along a vertical longitudinal plane that passes through a center of the body and the concave-shaped sidewalls being configured to complement a shape of the two adjacent fingers on a user's hand. For example, as previously described in connection with at least FIGS. 1-9, a user can grip the concave-shaped sidewalls of handle 180 of body 200 of apparatus 100 between adjacent sides of two adjacent fingers on the user's hand. Handle 180 extends centrally along a top surface of body 200 along vertical longitudinal plane 500 that passes through a center of body 200. The concave-shaped sidewalls are configured to complement a shape of the two adjacent fingers on the user's hand.

Step 1004 includes while gripping the concave-shaped sidewalls, disposing the thumb of the user's hand, in a resting position, directly on at least one selector that is disposed on a side of the body and sufficiently offset from the handle in the posterior direction to allow the thumb to be naturally so-disposed. For example, as previously described in connection with at least FIGS. 1-9, while gripping the concave-shaped sidewalls, the user can dispose their thumb, in a resting position, directly on selector(s) 120, 130 that is/are disposed on a side of body 200 and sufficiently offset from handle 180 in the posterior direction to allow the thumb to be naturally so-disposed.

Step 1006 includes using the user's thumb, while naturally so-disposed, to select an oscillatory pattern for a flexible vibrating fin that extends away from a bottom surface of the body of the apparatus. For example, as previously described in connection with at least FIGS. 1-9, the user can use their thumb, while naturally so-disposed, to select an oscillatory pattern for flexible vibrating 160 fin that extends away from a bottom surface 300 of body 200 of apparatus 100.

Step 1008 includes disposing the bottom surface of the body of the apparatus on the user's body such that the flexible vibrating fin is in direct contact with and massages a desired portion of the user's body. For example, as previously described in connection with at least FIGS. 1-9, the user can dispose substantially planar bottom surface 300 of body 200 of apparatus 100 on their body such that flexible vibrating fin 160 is in direct contact with, and massages, a desired portion of the user's body.

Such an example method may additionally or alternatively include any suitable steps and/or actions corresponding to any functional and/or structural characteristic of any component or part of apparatus 100 as described in this disclosure.

Example Methods of Manufacture

The disclosure now turns to one or more example methods of manufacturing a handheld vibrating apparatus as described anywhere in this disclosure.

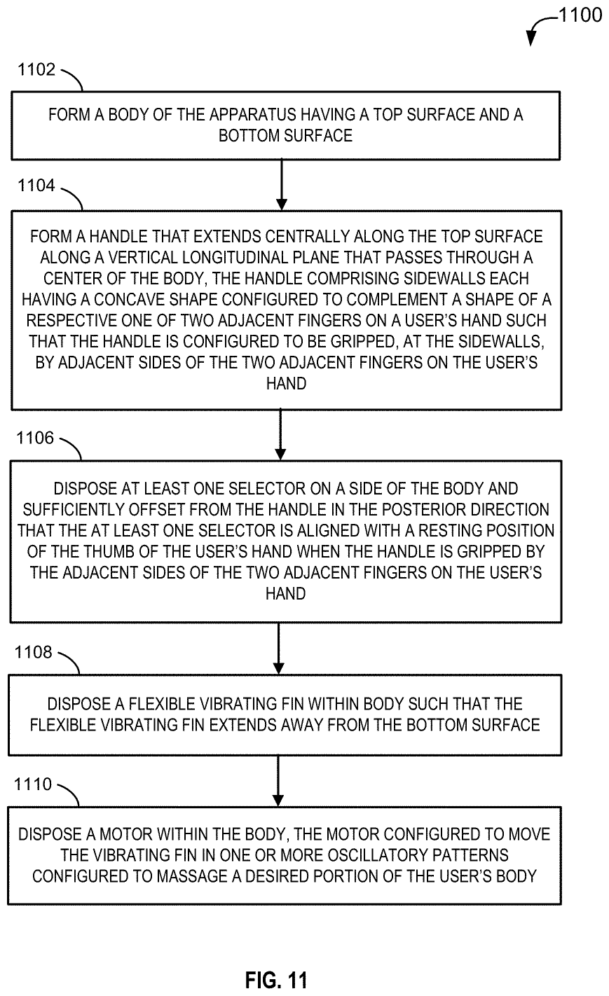

FIG. 11 illustrates a flowchart 1100 for an example method of manufacturing a handheld vibrating apparatus, as described anywhere in this disclosure. Although particular steps are described herein, the present application is not so limited and alternative methods of manufacturing a handheld vibrating apparatus, as described anywhere herein, may include a subset of these steps, in the same or different order, and may additionally include one or more addition steps not described herein.

Step 1102 includes forming a body of the apparatus having a top surface and a bottom surface. For example, as previously described in connection with at least FIGS. 1-9, body 200 of apparatus 100 can be formed to have a substantially rounded top surface 250 and a substantially planar bottom surface 300.

Step 1104 includes forming a handle that extends centrally along the top surface along a vertical longitudinal plane that passes through a center of the body, the handle comprising sidewalls each having a concave shape configured to complement a shape of a respective one of two adjacent fingers on a user's hand such that the handle is configured to be gripped, at the sidewalls, by adjacent sides of the two adjacent fingers on the user's hand. For example, as previously described in connection with at least FIGS. 1-9, handle 180 can be formed to extend centrally along the top surface along vertical longitudinal plane 500 that passes through a center of body 200. Handle 180 includes sidewalls that each have a concave shape configured to complement the shape of a respective one of two adjacent fingers on a user's hand such that handle 180 is configured to be gripped, at the sidewalls, by adjacent sides of the two adjacent fingers on the user's hand.

Step 1106 includes disposing at least one selector on a side of the body and sufficiently offset from the handle in the posterior direction that the at least one selector is aligned with a resting position of the thumb of the user's hand when the handle is gripped by the adjacent sides of the two adjacent fingers on the user's hand. For example, as previously described in connection with at least FIGS. 1-9, selector(s) 120, 130 can be disposed on a side of body 200 and sufficiently offset from handle 180, in the posterior direction, that selector(s) 120, 130 is/are aligned with a resting position of the user's thumb of the same hand as the two adjacent fingers that grip handle 180.

Step 1108 includes disposing a flexible vibrating fin within body such that the flexible vibrating fin extends away from the bottom surface. For example, as previously described in connection with at least FIGS. 1-9, flexible vibrating fin 160 can be disposed within body 200 such that flexible vibrating fin 160 extends away from bottom surface 300.

Such an example method may additionally or alternatively include any suitable steps and/or actions for forming, providing, disposing, connecting, removing or creating any functional and/or structural characteristic of any component or part of apparatus 100 as described in this disclosure.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A handheld vibrating apparatus, comprising:
a body comprising:
a handle extending centrally along a top surface of the body along a vertical longitudinal plane that passes through a center of the body, the handle comprising sidewalls each having a concave shape configured to complement a shape of a respective one of two adjacent fingers on a user's hand such that the handle is configured to be gripped, at the sidewalls, by adjacent sides of the two adjacent fingers on the user's hand,
at least one selector disposed on a side of the body and sufficiently offset from the handle in the posterior direction that the at least one selector is aligned with a resting position of the thumb of the user's hand when the handle is gripped by the adjacent sides of the two adjacent fingers on the user's hand, and
a bottom surface;
a flexible vibrating fin extending away from the bottom surface; and
a motor configured to move the vibrating fin in one or more oscillatory patterns configured to massage a desired portion of the user's body.

2. The apparatus of claim 1, wherein the flexible vibrating fin has a shape of at least a tip of a human tongue.

3. The apparatus of claim 1, further comprising control circuitry configured to regulate at least one aspect of operation of apparatus.

4. The apparatus of claim 1, wherein the at least one selector comprises a pattern selector configured to allow the user to select one of the one or more oscillator patterns for the vibrating fin upon being pressed for a first predetermined length of time.

5. The apparatus of claim 4, wherein the pattern selector is additionally configured to change a state of vibration of the vibrating fin between an ON state and an OFF state upon being pressed for a second predetermined length of time different from the first predetermined length of time.

6. The apparatus of claim 1, wherein the at least one selector comprises an intensity selector configured to allow a user to select one of a plurality of intensities for the one or more oscillatory patterns.

7. The apparatus of claim 1, further comprising a battery configured to power at least one component of the apparatus and a charging port configured to receive external electrical power for one or both of charging the battery and directly powering the apparatus.

8. The apparatus of claim 1, wherein the body is substantially symmetrical about the vertical longitudinal plane.

9. The apparatus of claim 1, wherein the bottom surface of the body is substantially planar.

10. The apparatus of claim 1, wherein the body has a substantially shoe shape that is symmetrical about the vertical longitudinal plane.

11. The apparatus of claim 10, wherein the body comprises a curved outer profile that increases in width from a front end of the body, along the vertical longitudinal plane, to a first local maximum value w₁, which then decreases to a local minimum width w₂ as the body extends further toward a back end of the body along the vertical longitudinal plane.

12. The apparatus of claim 11, wherein the width of the curved outer profile increases again from the local minimum value w₂ to a second local maximum width w₃ as the body extends further along the vertical longitudinal plane and before decreasing again at the back end of the body.

13. The apparatus of claim 1, wherein the body further comprises a substantially rounded top side.

14. The apparatus of claim 13, wherein the body further comprises at least one ridge extending along an outer contour of at least a portion of the rounded top side.

15. The apparatus of claim 1, wherein a minimum horizontal width of the handle between the sidewalls is smaller than a maximum horizontal width of a top of the handle, thereby preventing the apparatus from unintentionally falling out of the user's grip.

16. The apparatus of claim 15, wherein the top of the handle comprises a substantially ovoid or elliptical shape.

17. The apparatus of claim 1, wherein the handle is disposed posterior of an anterior-posterior midline of the body and substantially vertically in-line with the vibrating fin.

18. The apparatus of claim 1, wherein, when appropriately gripped by the user, the apparatus is configured to project substantially distally away from the user's hand and function substantially as a natural extension of the user's hand.

19. A method of using handheld vibrating apparatus, the method comprising:
gripping concave-shaped sidewalls of a handle of a body of the apparatus between adjacent sides of two adjacent fingers on a user's hand, the handle extending centrally along a top surface of the body along a vertical longitudinal plane that passes through a center of the body and the concave-shaped sidewalls being configured to complement a shape of the two adjacent fingers on the user's hand;
while gripping the concave-shaped sidewalls, disposing the thumb of the user's hand, in a resting position, directly on at least one selector that is disposed on a side of the body and sufficiently offset from the handle in the posterior direction to allow the thumb to be naturally so-disposed;
using the user's thumb, while naturally so-disposed, selecting an oscillatory pattern for a flexible vibrating fin that extends away from a bottom surface of the body of the apparatus; and
disposing the bottom surface of the body of the apparatus on the user's body such that the flexible vibrating fin is in direct contact with and massages a desired portion of the user's body.

20. A method of manufacturing a handheld vibrating apparatus, the method comprising:
forming a body of the apparatus having a top surface and a bottom surface;
forming a handle that extends centrally along the top surface along a vertical longitudinal plane that passes through a center of the body, the handle comprising sidewalls each having a concave shape configured to complement a shape of a respective one of two adjacent fingers on a user's hand such that the handle is configured to be gripped, at the sidewalls, by adjacent sides of the two adjacent fingers on the user's hand;
disposing at least one selector on a side of the body and sufficiently offset from the handle in the posterior direction that the at least one selector is aligned with a resting position of the thumb of the user's hand when the handle is gripped by the adjacent sides of the two adjacent fingers on the user's hand; and
disposing a flexible vibrating fin within body such that the flexible vibrating fin extends away from the bottom surface; and
disposing a motor within the body, the motor configured to move the vibrating fin in one or more oscillatory patterns configured to massage a desired portion of the user's body.
